(19) United States
(12) Patent Application Publication
(10) Pub. No.: US 2003/0021964 A1
(43) Pub. Date: Jan. 30, 2003

(54) Ink jet recording medium

(75) Inventors: Manabu Kaneko, Tokyo (JP); Kazumasa Matsumoto, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA CORPORATION, Tokyo (JP)

(21) Appl. No.: 10/163,739

(22) Filed: Jun. 6, 2002

(30) Foreign Application Priority Data
Jun. 14, 2001 (JP) 179966/2001

(51) Int. Cl. B41M 5/00

(52) U.S. Cl. 428/195

(57) ABSTRACT

An ink-jet recording medium having a support and an ink absorbing layer comprising fine inorganic particles and a binder is disclosed. In the ink-jet recording medium the average diameter of said fine inorganic particles is from 5 to 100 nm; said binder comprises an emulsion resin which is prepared by emulsion polymerization employing a polymer dispersing agent having a hydroxyl group; and the weight ratio of said fine inorganic particles to said binder is from 2:1 to 10:1.

An ink jet recording medium which exhibits high glossiness as well as a high ink absorbing rate, and results in no cracking as well as no peeling off while not forming minute pieces when rolled or folded, is provided.

### FIELD OF THE INVENTION

The present invention relates to an ink jet recording medium (hereinafter occasionally referred simply to as a recording medium).

### BACKGROUND OF THE INVENTION

In recent years, the image quality of ink jet printing has increasingly improved and is approaching conventional photographic quality. Particularly, regarding final print quality, the role of the recording media is markedly enhanced.

Examples of such recording media, which result in high image quality, include ink jet recording media comprised of a support having thereon a swelling type ink absorbing layer comprised mainly of hydrophilic binders. Said recording media result in image appearance approaching conventional photography. On the other hand, in said ink jet recording method, its recording speed has increasingly been enhanced and recording media are required to exhibit higher ink absorbability as well as higher drying properties. However, ink jet recording media, comprising a swelling type ink absorbing layer, have resulted in problems in which the ink jet recording media, having a swelling type ink absorbing layer results in low ink absorption rate, and when applied to high speed recording, images tend to result in mottled unevenness due to united ink droplets.

In order to overcome such problems, the ink absorbing rate is enhanced by providing a porous ink absorbing layer, comprised of voids, which is formed by employing a relatively small amount of hydrophilic binders, crosslinking agents and a relatively large amount of fine inorganic particles, and ink jet recording media, comprising such a layer, are known. Employed as said fine inorganic particles are particles having a diameter of approximately 1 μm, as well as particles having a diameter of less than or equal to 100 nm.

Ink jet recording media, employing fine inorganic particles having a diameter of approximately 1 μm, exhibit excellent ink absorbability, but exhibit low glossiness due to degraded surface smoothness. On the other hand, when fine inorganic particles having a diameter of less than or equal to 100 nm, are used, the resultant recording media exhibit desired ink absorbability as well as appearance approaching conventional photography due to high smoothness of the ink absorbing layer.

However, the void type recording media, as above, result in relatively high brittleness of their ink absorbing layer. As a result, when said recording media are rolled or folded, the ink absorbing layer occasionally cracks. Since glossiness of said ink absorbing layer is inherently low, cracks due to folding are not too well noticeable. However, it was discovered that high gloss recording media, employing fine inorganic particles having a diameter of less than or equal to 100 nm, resulted in readily noticeable cracking when folded.

Further, when, as a support, non-water absorbing supports, such as plastic resin films and supports prepared by covering both surfaces of paper with plastic resins, were used, it was discovered that problems occurred in which when said ink absorbing layer resulted in cracking, said layer would peel off resulting in minute loose pieces due to weak adhesion between said ink absorbing layer and the surface of said support.

An ink jet recording medium having porous layer comprising silica prepared by gas phase method and polyvinyl alcohol as a binder is known in the art. The ink absorbing layer becomes brittle at the dried condition and the medium has a problem that the ink layer is cracked when the medium is bent.

In order to overcome these problems, heretofore, methods have been tried in which emulsion resins or latex particles are incorporated into said ink absorbing layer. However, when the addition amount is increased, problems occurs in which the resultant glossiness is lowered due to the formation of cracks, as well as wrinkles on said ink absorbing layer. Heretofore, improvement has not been sufficient.

### SUMMARY OF THE INVENTION

An object of the present invention is to solve the aforesaid problems, and specifically to provide an ink jet recording medium which results in cracks as well as no minute peeled-off pieces after being rolled or folded.

The aforesaid objects of the present invention are achieved employing the embodiments described below.

In an ink-jet recording medium which comprises a support having thereon an ink absorbing layer comprised of fine inorganic particles as well as a binder, an ink jet recording medium wherein the average diameter of said fine inorganic particles is from 5 to 100 nm; said binder is comprised of an emulsion resin which is prepared by emulsion polymerization employing a polymer dispersing agent having a hydroxyl group; and the weight ratio of said fine inorganic particles to said binder is from 2:1 to 10:1.

The preferable polymer dispersing agent is polyvinyl alcohol.

An average degree of polymerization of the polyvinyl alcohol is preferably 300 to 5,000 and more preferably 1,500 to 5,000.

In the ink jet recording medium, the Tg of said emulsion resin is preferably 20° C. or less.

In the ink jet recording medium, the binder is preferably comprised of a water-soluble resin and an emulsion resin which is prepared by emulsion polymerization employing polyvinyl alcohol as a dispersing agent.

In the ink jet recording medium, the water-soluble resin is polyvinyl alcohol.

The ink jet recording medium preferably contains boric acid, or a salt thereof, in said ink absorbing layer in an amount of 0.2 to 2 g/m².

The non-water absorbing support is preferably employed.

### DETAILED DESCRIPTION OF THE INVENTION

The present invention will now be detailed.

The present invention is applied to a void type ink jet recording medium which comprises a support having thereon an absorbing layer comprised of a porous layer having voids comprising at least fine inorganic particles and a binder.

Listed as examples of fine inorganic particles employed in the present invention are precipitated calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, non-crystalline synthetic silica, alumina, colloidal alumina, pseudo boehmite, aluminum hydroxide, lithopone, zeolite, and magnesium hydroxide.

These fine inorganic particles may be employed in a state in which their primary particles are uniformly dispersed into a binder without any modification. Alternately, they may be employed in a state in which secondary aggregated particles are formed and are dispersed into said binder.

The average diameter of said fine inorganic particles is preferably from 5 to 100 nm. When said average particle diameter exceeds 100 nm, it becomes difficult to maintain the desired high gloss.

The average diameter of fine inorganic particles, as described herein, can be determined as follows. Either the cross-section, or the surface of said layer having voids, is observed employing a scanning type electron microscope. The diameter of a plurality of randomly selected particles is determined and said average particle diameter can be obtained as a simple average value (being a number average value). Herein, said particle diameter is expressed as the diameter of a circle having the same projection area as that of each particle.

In the present invention, from the viewpoint of the fact that particularly minute voids can be prepared in the ink absorbing layer, silica or pseudo boehmite is preferred. Silica or pseudo boehmite, having an average diameter of 10 to 90 nm, which is synthesized employing a gas phase method, is particularly preferred.

The amount of fine inorganic particles employed in said ink absorbing layer varies depending on the types of fine inorganic particles as well as the types of binders, but is commonly from 5 to 30 g per m² of the recording medium, and is preferably from 10 to 25 g.

In the present invention, the binders employed in said ink absorbing layer include emulsion resins which are prepared by emulsion polymerization employing a polymer dispersing agent having a hydroxyl group.

The emulsion resin is prepared by a way that an oil soluble being kept in an emulsion state is polymerized by employing a polymerization initiator. A dispersing agent is employed in the emulsion polymerization, examples of which includes, in general, a low molecular weight dispersing agent such as alkyl sulfonate, alkylbenzene sulfonate, diethyl amine, ethylenediamine, and quaternary ammonium salt, and a high molecular weight dispersing agent such as polyoxyethylene nonylphenyl ether, polyoxyethylene lauryl ether, hydroxyethyl cellulose, and polyvinyl pyrrolidone.

The emulsion resin according to the invention is obtained by emulsion polymerization by employing a polymer dispersing agent having a hydroxyl group.

The polymer dispersing agent having a hydroxyl group, as described herein, refer to a polymer dispersing agent having an average molecular weight of at least 10,000 in which a hydroxyl group is substituted on the side chain or the terminal. Listed as said polymer dispersing agent are, for example, those prepared by copolymerizing 2-ethylhexyl acrylate with acryl based polymers such as sodium polyacrylate and polyacrylamide, polyethers such as polyethylene glycol and polypropylene glycol, and polyvinyl alcohol. Of these, polyvinyl alcohol is particularly preferred.

Polyvinyl alcohol employed as said polymer dispersing agent include, in addition to common polyvinyl alcohol prepared by hydrolyzing polyvinyl acetate, modified polyvinyl alcohol such as cation modified polyvinyl alcohol, anion modified polyvinyl alcohol having an anionic group such as a carboxylic group, and silyl modified polyvinyl alcohol having a silyl group. The polyvinyl alcohol having an average degree of polymerization of 300 to 5,000 is preferable, in view of easy handling as well as good effect in inhibiting occurrence of cracking of the ink absorbing layer. The average degree of polymerization is more preferably 1,500 to 5,000, and, in particular, 3,000 to 4,500 is preferable. The polyvinyl alcohol has a saponification degree of preferably 70 to 100 mol %, and more preferably 80 to 99.5 mol %.

Listed as resins which undergo emulsion polymerization employing the aforesaid polymer dispersion agents are acrylic acid esters, methacrylic acid esters, vinyl based compounds, ethylene based monomers such as styrens based compound, and homopolymers or copolymers of diene based compound such as isoprene. For example, listed are acryl based resins, styrene-butadiene based resins, and ethylene-vinyl acetate based resins.

The emulsion resin employed in the ink absorbing layer of the invention is fine resin particles having an average particle diameter of 0.01 to 2 μm dispersed in aqueous medium as an emulsion state, and is produced by emulsion polymerization of oil soluble monomer by employing a polymer dispersing agent having hydroxy group. The chemical composition of the polymer is not fundamentally different from each other depending upon the kind of dispersing agent employed in the polymerization. However, the emulsion resin polymerized by employing polymer dispersing agent having hydroxy group are presumed to have hydroxy group at least surface of the particles of the emulsion resin, and the chemical and physical properties of the emulsion resin seem to be different from those polymerized by employing other dispersing agents than the polymer dispersing agent having hydroxy group.

The emulsion resin provide said layer having voids with flexibility during the formation of said layer having voids. Those resins, which exhibit flexible properties even at room temperature, are suitable. Those, which forms said layer upon fusing at room temperature, are more preferred. At that time, the Tg of a film prepared by employing said emulsion resin is preferably less than or equal to 20° C., and is more preferably from −40° C. to 10° C.

Transparency of the ink absorbing layer is reduced due to the light scattering in the ink absorbing layer and thereby image density is decreased when the ink absorbing layer contains a particles having large average particle diameter. Therefore, the particle diameter of the emulsion resin prepared by emulsion polymerization employing said polymer dispersing agent having a hydroxyl group, is preferably from 0.01 to 2 μm, and is most preferably from 0.05 to 1.5 μm. Further, the inorganic fine particles used in ink absorbing layer has preferably an average particle diameter of 5 to 100 nm, and more preferably the inorganic fine particles are employed in combination with the emulsion resin having particle diameter of 0.05 to 1.0 μm in the ink absorbing layer. The weight of inorganic fine particles is preferably 2 to 10 times of the weight of the binder. The particle diameter of the emulsion resin is particularly preferably 0.05 to 0.5 μm.

Production method of emulsion resins prepared by emulsion polymerization employing the polymer dispersing agent having a hydroxyl group are not particularly restricted.

Listed as such emulsion resins, which are commercially available, are, for example, vinyl acetate based emulsions such as Vinyzol 480 and Vinyzol 2023, manufactured by Daido Chemical Industry Co., Ltd.; vinyl acetate based emulsions such as VINYBLAN 1108W and VINYBLAN 1084, and acryl based emulsions such as VINYBLAN 2597 and VINYBLAN 2561, manufactured by Nissin Chemical Industry Co., Ltd.; and vinyl acetate-ethylene based emulsions such as Sumikaflex S-400 and Sumikaflex S-400, manufactured by SUMITOMO CHEMICAL CORP., LTD.

The emulsion resin obtained by emulsion polymerization employing the polymer dispersing agent having a hydroxy group according to the invention can minimize generation of wrinkle and cracks in ink absorbing layer during preparation of ink jet recording material. Though the mechanism is not clearly investigated, it is presumed that the combination the emulsion resin with inorganic fine particles is effective to minimize the generation of wrinkle and cracks. The emulsion resin is considered to have hydroxy group at the surface of the emulsion particles derived from the polymer dispersing agent having hydroxy group, and the hydroxy group at the surface forms hydrogen bond with hydroxy group at the surface of the inorganic fine particles, whereby adhesion strength of the emulsion resin to the inorganic fine particles is improved. Further the emulsion resin has good compatibility with the other binder component since the emulsion resin and the binder component are both organic material, and, therefore, the emulsion resin, the inorganic fine particles and the binder component form strong bonding in the ink absorbing layer. Consequently a flexible ink absorbing layer with minimized crack is formed because the brittleness is improved.

The invention is effective for the medium having porous layer comprising silica prepared by a gas phase method as the inorganic particles. The silica prepared by a gas phase method is advantageous since it contributes to form preferable minute voids in an ink absorbing layer as described before. However, the silica prepared by a gas phase method has relatively such small number of hydroxy groups at the surface thereof as from 2 to 3 per nm², and a hydroxy group is difficult to form intramolecular bond with the other hydroxy group nearby, and more lone hydroxy groups remain, and the silica prepared by a gas phase method is likely to form hydrogen bond easily with other molecule.

Therefore, the silica prepared by a gas phase method is advantageous in combination with the emulsion resin obtained by emulsion polymerization employing the polymer dispersing agent having a hydroxy group according to the invention.

The average particle diameter of the inorganic particles is smaller, the more advantage of the invention appears since specific area is larger.

As binders, emulsion resins prepared by emulsion polymerization employing a polymer dispersing agent having a hydroxyl group may be employed individually or in combination with other water-soluble resins or hydrophobic resins. When employed in such combination, water-soluble resins are preferred.

Listed as water-soluble resins employed in combination may be gelatin, polyvinyl alcohol, polyvinyl pyrrolidone, polyethylene oxide, hydroxyethyl cellulose, agar-agar, pullulan, dextrin, acrylic acid, carboxymethyl cellulose, casein, and alginic acid. These may be employed in combination of at least two types. Of these, preferred water-soluble resin is polyvinyl alcohol.

Polyvinyl alcohol employed in combination includes modified polyvinyl alcohol such as cation modified polyvinyl alcohol, anion modified polyvinyl alcohol having an anionic group, and silyl modified polyvinyl alcohol which is substituted by a silyl group.

Polyvinyl alcohol employed, in combination, which has an average degree of polymerization of at least 300 is preferably employed, and polyvinyl alcohol which has an average degree of polymerization of 1,000 to 5,000 is more preferably employed, and in particular, the average degree of polymerization of 2,000 to 4,500 is preferable. On the other hand, the ratio of saponification of said polyvinyl alcohol is preferably from 70 to 100 mol percent, and is most preferably from 80 to 99.5 mol percent.

When emulsion resins, which are prepared by emulsion polymerization employing a polymer dispersing agent having a hydroxyl group, are employed together with other water-soluble resins or hydrophobic resins, the ratio of said emulsion resins in binders is preferably at least 5 percent by weight, and is most preferably at least 10 percent by weight.

The ratio of fine inorganic particles to binders which are employed to form said void type ink absorbing layer is from 2:1 to 10:1 in terms of weight ratio. When the amount of binders exceeds the upper limit, ink absorbability is degraded due to no formation of voids. On the other hand, when the amount of binders is excessively small, layer forming properties are degraded, whereby it becomes difficult to form a layer due to cracking during drying.

In order to improve layer forming properties as well as to enhance waterfastness of the layer, it is possible to use hardeners. Listed as hardeners are, for example, epoxy based hardeners such as diglycidyl ether, ethylene glycol glycidyl ether, sorbitol polyglycidyl ether, and N,N-diglycidyl-4-glycidylpxyaniline; aldehyde based hardeners such as formaldehyde and glyoxal; active halogen based hardeners such as 2,4-dichloro-4-hydroxy-1,3,5-s-trizine; active vinyl based hardeners such as bisvinylsulfonyl methyl ether; isocyanate based compounds; and boric acids and salts thereof. Of these, boric acids and salts thereof are particularly preferred.

Boric acids or salts thereof refer to oxygen acids having a boron atom as the central atom and salts thereof, and specifically include orthoboric acid, metaboric acid, hypoboric acid, tetraboric acid, and pentaboric acid, and salts thereof.

Said hardeners may be employed in combination of at least two types. The employed amount may vary depending on the amount of fine inorganic particles as well as binders in the coating composition, but the employed amount in said ink absorbing layer is preferably from 0.1 to 4 g per m². When boric acids or salts thereof are employed as hardeners, the amount of said boric acids or salts thereof is preferably from 0.1 to 2 g.

The amount of boric acids or salts thereof, as described herein, refers to the value determined in such a manner that boric acid ions are extracted from the ink absorbing layer of a 1 m² ink jet recording medium employing hot water and the amount of extracted boric acid ions is determined employing ion chromatography.

Methods for adding said hardeners to said ink absorbing layer include a method in which said hardeners are added to an ink absorbing layer forming coating composition during coating and a method in which after applying a coating composition and subsequently drying said coating, a hardening agent solution may be overcoated onto the resultant layer.

Various types of additives, other than those previously described, may be added to the ink absorbing layer of the ink jet recording media of the present invention, as well as other layers which may be provided if desired.

For example, in order to enhance waterfastness after printing as well as bleeding resistance, it is possible to add cationic resins or water-soluble polyvalent metal ions.

Cationic polymers may be optionally selected from polymers having a primary, secondary, or tertiary amino group and a quaternary ammonium salt group and then employed. From the viewpoint of minimum discoloration during storage as well as minimum degradation of lightfastness, polymers having a quaternary ammonium salt are preferred. Further, homopolymers, having an average molecular weight of 2,000 to 100,000, of a monomer having a quaternary ammonium salt group, and copolymers or condensation polymer, having said average molecular weight, of said monomer with one or more other copolymerizable monomers, are preferred.

Listed as water-soluble polyvalent metal ions are bivalent metal ions such as Mg²⁺, Ca²⁺and Zn²⁺, trivalent metal ions such as Al³⁺, and tetravalent or higher valent metal ions such as Ti⁴⁺. These water-soluble polyvalent metal ions are added in the form of salts such as sulfites, sulfates, nitrates, chlorates, acetates, carbonates, and p-toluenesulfonate. Further, employed as salts of water-soluble polyvalent ions may be water-soluble inorganic polymers such as polychlorinated aluminum.

Cationic resins or water-soluble polyvalent metal ions may be directly added to a coating composition and applied. In addition, after coating and drying of the recording medium, an aqueous solution of cationic resins or water-soluble polyvalent ions may be overcoated onto the resulting coating and subsequently dried.

In addition to additives described above, the following additives known in the art may be incorporated: for example, UV absorbers described in Japanese Patent Publication Open to Public Inspection Nos. 57-74193, 5787988, and 62-261476; anti-discoloring agents described in Japanese Patent Publication Open to Public Inspection Nos.57-74192, 57-87989, 60-72785, 61-146591, 1-95091, and 3-13376; optical brightening agents described in Japanese Patent Publication Open to Public Inspection Nos. 59-42993, 59-52689, 62-280069, 61-242871, and 4-219266; pH regulators such as sulfuric acid, phosphoric acid, citric acid, sodium hydroxide, potassium hydroxide, and potassium carbonate; antifoaming agent; thickeners; antistatic agents; and matting agents.

Said porous ink absorbing layer may be comprised of at least two layers. In such a case, each structure of the absorbing layers may be the same or different.

Employed as supports of the ink jet recording medium of the present invention may be conventional supports known in the art. The present invention effectively minimizes the phenomena in which said ink absorbing layer peels off resulting in minute loose pieces, particularly, when non-water absorbing support is used as the support.

When conventional void type high gloss recording media, comprising fine inorganic particles, which are prepared employing non-water absorbing plastic resin film as their support, or non-water absorbing supports of which surfaces are covered with plastic resins, are folded at low humidity, their hard ink layer occasionally results in minute cracking and peels off resulting in minute loose pieces. Said phenomena occur due to the fact that the smoothness of the surface of said non-water absorbing support is superior to water absorbing supports and adhesion between said support and said ink absorbing layer is insufficient.

When the structure of the present invention is employed, a flexible ink absorbing layer does not crack at low humidity. Further, it is assumed that since adhesion between said ink absorbing layer and the support is enhanced due to the presence of the emulsion resins prepared by emulsion polymerization employing a polymer dispersing agent having a hydroxyl group, said ink absorbing layer does not peel off.

Listed as non-water absorbing supports are plastic resinous film supports and supports prepared by covering both sides of a paper medium with plastic resinous film.

Listed as plastic resinous film supports are polyester film, polyvinyl chloride film, polypropylene film, cellulose acetate film, and polystyrene film or laminates thereof. Any of these plastic resinous films, which are transparent or translucent, may be employed.

Supports, which are prepared by covering both surfaces of paper with plastic resinous film, are those which are prepared by covering both surfaces of paper with polyolefin. Preferably employed as polyolefin resins employed to cover both surfaces of paper are polyethylene, polypropylene, and polyisobutylene. Of these, polyolefins such as copolymers comprised of polypropylene as a main component are preferred and polyethylene is particularly preferred.

The thickness of supports is preferably from 50 to 350 μm, and is more preferably from 80 to 300 μm.

Various types of hydrophilic layers of the ink jet recording medium of the present invention such as an ink absorbing layer, a subbing layer and various hydrophilic layers suitably provided if desired, may be applied onto a support employing a method which is suitably selected from any of those known in the art. The preferred method is that a coating composition, which constitutes each layer, is applied onto a support and subsequently dried. In said method, it is possible to simultaneously apply at least two layers on a support and simultaneous coating is particularly preferred in which all the layers are simultaneously coated.

Preferably employed as coating systems are a roll coating method, a rod bar coating method, an air knife coating method, a spray coating method, and a curtain coating method, or an extrusion coating method employing a hopper, described in U.S. Pat. No. 2,681,294.

The pH of the recording surface of the ink jet recording medium of the present invention is preferably from 3.5 to 9. When the surface pH is at least 3.5, it is possible to markedly minimize so-called bronzing which refers to the formation of metallic gloss due to deposit of dyes during ink jet recording. On the other hand, when the surface pH is less than or equal to 9, it is possible to markedly minimize phenomena in which recorded images are subject to bleeding.

The surface pH of the recording layer according to the present invention was determined as follows. Said pH was measured after 30 seconds employing distilled water, based on the method described in J. TAPPI Paper Pulp Test Method No. 49.

In the present invention, it is possible to adjust the surface pH of the recording layer to the specified range by overcoating suitable pH regulators after forming said recording layer. Employed as pH regulators may be suitable aqueous acid and alkali solution. In such a case, it is possible to suitably select types of acids and alkalis and their concentration, based on the adjusted pH range.

When image recording is carried out employing the ink jet recording medium of the present invention, a method, in which water based ink is employed, is preferably employed. Said water based ink may be a water based dye ink or a water based pigment ink. The water based dye ink or water based pigment ink, as described herein, refers to the recording liquid which comprises the coloring agents and the liquid media described below, as well as other additives.

Employed as coloring agents are water-soluble dyes such as direct dyes, acidic dyes, basic dyes and reactive dyes which are known in the art regarding ink jet printing or food dyes and also water based pigments which include organic pigments such as azo pigments, phthalocyanine pigments, and dye lakes and inorganic pigments such as carbon black.

Listed as other additives added to said water based ink may be, for example, water-soluble organic solvents (for example, propanol, hexanol, ethylene glycol, diethylene glycol, glycerin, hexanediol, and urea), surface active agents, water-soluble polymers, antiseptics, mildewcides, viscosity modifiers, and pH regulators.

The production example of emulsion resins will now be described.

The pH of 400 g of 5 percent aqueous polyvinyl alcohol (having a degree of polymerization of 1,700 and a saponification ratio of 88.5 mol percent) solution was adjusted to 3.5. Subsequently, 50 g of methyl methacrylate and 50 g of butyl acrylate were added while stirring to the resultant solution and the resultant mixture was heated to 60° C. Thereafter, 10 g of 5 percent aqueous ammonium persulfate solution was added and the resultant mixture underwent polymerization. After 15 minutes, 100 g of methyl methacrylate and 100 g of butyl acrylate were gradually added over 3 hours. After 5 hours, when the polymerization ratio reached 99.9 percent, the resultant product was cooled and its pH was adjusted to 7.0 as a neutral mixture, whereby Emulsion (1) was synthesized. The resultant emulsion was dried at 60° C. employing a vacuum dryer. Subsequently, the Tg was determined employing a differential scanning calorimeter, resulting in 5° C.

Emulsions (2) through (14), shown in Table 1, were synthesized employing the same method.

TABLE 1

| | | | | Solid |
|---|---|---|---|---|
| | | | | Concen- |
| No. | Monomer | Dispersing Agent | Tg | tration |
| (1) | methyl | PVA (degree of | 5° C. | 44% |
| | methacrylate + | polymerization: 1700; | | |
| | butyl acrylate | saponification ratio: | | |
| | | 88.5%) | | |
| (2) | methyl | PVA (degree of | 5° C. | 44% |
| | methacrylate + | polymerization: 500; | | |
| | butyl acrylate | saponification ratio: | | |
| | | 88.5%) | | |
| (3) | methyl | PVA (degree of | −10° C. | 44% |
| | methacrylate + | polymerization: 1700; | | |
| | 2-ethylhexyl | saponification ratio: | | |
| | acrylate | 88.5%) | | |
| (4) | methyl | PVA (degree of | −10° C. | 44% |
| | methacrylate + | polymerization: 1700; | | |
| | 2-ethylhexyl | saponification ratio: | | |
| | acrylate | 98.5%) | | |
| (5) | methyl | PVA (degree of | 15° C. | 44% |
| | methacrylate + | polymerization: 1700; | | |
| | butyl acrylate | saponification ratio: | | |
| | | 88.5%) | | |
| (6) | styrene + | PVA (degree of | 0° C. | 44% |
| | butadiene | polymerization: 1700; | | |
| | | saponification ratio: | | |
| | | 98.5%) | | |
| (7) | styrene + | PVA (degree of | 0° C. | 44% |
| | butadiene | polymerization: 500; | | |
| | | saponification ratio: | | |
| | | 88.5%) | | |
| (8) | ethylene + | PVA (degree of | 5° C. | 44% |
| | vinyl acetate | polymerization: 1700; | | |
| | | saponification ratio: | | |
| | | 88.5%) | | |
| (9) | ethylene + | PVA (degree of | 5° C. | 44% |
| | vinyl acetate | polymerization: 500; | | |
| | | saponification ratio: | | |
| | | 88.5%) | | |
| (10) | methyl | PVA (degree of | 30° C. | 44% |
| | methacrylate + | polymerization: 1700; | | |
| | butyl acrylate | saponification ratio: | | |
| | | 88.5%) | | |
| (11) | methyl | PVA (degree of | 0° C. | 44% |
| | methacrylate + | polymerization: 3500; | | |
| | butyl acrylate | saponification ratio: | | |
| | | 88.5%) | | |
| (12) | methyl | PVA (degree of | −30° C. | 44% |
| | methacrylate + | polymerization: 1700; | | |
| | butyl acrylate | saponification ratio: | | |
| | | 88.5%) | | |
| (13) | styrene + | sodium | 0° C. | 44% |
| | butadiene | alkylbenzenesulfonate | | |
| (14) | methyl | sodium | −10° C. | 44% |
| | methacrylate + | alkylbenzenesulfonate | | |
| | 2-ethylhexyl | | | |
| | acrylate | | | |

### EXAMPLES

The present invention will now be specifically described with reference to examples. However, the present invention is not limited to the embodiments described in the examples.

### Example 1

Fine silica particles (Reorosil QS-20, manufactured by Tokuyama Corp.) prepared by a gas phase method were dispersed into pure water having a pH which was adjusted to 2.5, employing nitric acid, and 400 g of a 20 percent silica dispersion were prepared. Added to said silica dispersion were 80 g of a 20 percent aqueous Cationic Polymer (1) solution having a pH which was adjusted to 2.5 and 60 ml of an aqueous solution in which 2.1 g of boric acid and 1.5 g of borax were dissolved, and the resultant mixture was subjected to dispersion employing a high pressure homogenizer. While stirring at 40° C., 18.2 g of Emulsion (1) described in Table 1 and 80 ml of 10 percent aqueous solution of polyvinyl alcohol (PVA235, manufactured by Kuraray) were added. Subsequently, the total volume of the resultant mixture was adjusted to 1,000 ml by adding pure water, whereby translucent Coating Composition (1) was prepared.

Cationic Polymer (1)

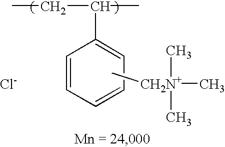

Subsequently, said Coating Composition (1) was applied onto the recording surface of the support described below so as to obtain a wet layer thickness of 180 μm. The resultant coating was cooled at 8° C. for 10 seconds, and subsequently dried, employing 20 to 40° C. airflow, whereby Ink Jet Recording Medium 1 was prepared. Said support (at a thickness of 260 μm and 6 percent anatase type titanium dioxide was incorporated into the recording side of the polyethylene layer) was prepared by covering both surfaces of a basis weight 200 g/m² base paper with polyethylene.

### Example 2

Ink Jet Recording Medium 2 was prepared in the same manner as Example 1, except that when Coating Composition (1) was prepared, 18.2 g of Emulsion (1) was replaced with 4.5 g of Emulsion (2) described in Table 1, and 80 ml of 10 percent aqueous polyvinyl alcohol solution was replaced with 180 ml of the same.

### Example 3

Ink Jet Recording Medium 3 was prepared in the same manner as Example 1, except that when Coating Composition (1), was prepared, Emulsion (1) was replaced with Emulsion (3), described in Table 1, having the same volume.

### Example 4

Ink Jet Recording Medium 4 was prepared in the same manner as Example 1, except that when Coating Composition (1) was prepared, 18.2 g of Emulsion (1) was replaced with 10.9 g of Emulsion (4) described in Table 1, and 80 ml of 10 percent aqueous polyvinyl alcohol solution was replaced with 112 ml of the same.

### Example 5

Ink Jet Recording Medium 5 was prepared in the same manner as Example 1, except that when Coating Composition (1), was prepared, Emulsion (1) was replaced with Emulsion (5), described in Table 1, having the same volume, and 80 ml of 10 percent aqueous polyvinyl alcohol solution was replaced with 187 ml of the same.

### Example 6

Ink Jet Recording Medium 6 was prepared in the same manner as Example 1, except that when Coating Composition (1) was prepared, 18.2 g of Emulsion (1) was replaced with 10.9 g of Emulsion (6) described in Table 1, and 80 ml of 10 percent aqueous polyvinyl alcohol solution was replaced with 112 ml of the same.

### Example 7

Ink Jet Recording Medium 7 was prepared in the same manner as Example 1, except that when Coating Composition (1) was prepared, 18.2 g of Emulsion (1) was replaced with 3.2 g of Emulsion (7) described in Table 1, and 80 ml of 10 percent aqueous polyvinyl alcohol solution was replaced with 186 ml of the same.

### Example 8

Ink Jet Recording Medium 8 was prepared in the same manner as Example 1, except that when Coating Composition (1) was prepared, Emulsion (1) was replaced with Emulsion (8), described in Table 1, having the same volume.

### Example 9

Ink Jet Recording Medium 9 was prepared in the same manner as Example 1, except that when Coating Composition (1) was prepared, 18.2 g of Emulsion (1) was replaced with 3.6 g of Emulsion (9) described in Table 1, and 80 ml of 10 percent aqueous polyvinyl alcohol solution was replaced with 144 ml of the same.

### Example 10

Ink Jet Recording Medium 10 was prepared in the same manner as Example 1, except that when Coating Composition (1) was prepared, 18.2 g of Emulsion (1) was replaced with 6.1 g of Emulsion (10) described in Table 1, and 80 ml of 10 percent aqueous polyvinyl alcohol solution was replaced with 240 ml of the same.

### Example 11

Ink Jet Recording Medium 11 was prepared in the same manner as Example 1, except that when Coating Composition (1) was prepared, 18.2 g of Emulsion (1) was replaced with 16.0 g of Emulsion (11) described in Table 1, and 80 ml of 10 percent aqueous polyvinyl alcohol solution was replaced with 112 ml of the same.

### Example 12

Ink Jet Recording Medium 12 was prepared in the same manner as Example 1, except that when Coating Composition (1) was prepared, 18.2 g of Emulsion (1) was replaced with 16.0 g of Emulsion (12) described in Table 1, and 80 ml of 10 percent aqueous polyvinyl alcohol solution was replaced with 112 ml of the same.

### Example 13

Ink Jet Recording Medium 13 was prepared in the same manner as Example 1, except that when Coating Composition (1) was prepared, 18.2 g of Emulsion (1) was replaced with 1.9 g of Emulsion (3) described in Table 1, and 80 ml of 10 percent aqueous polyvinyl alcohol solution was replaced with 259 ml of the same.

### Example 14

Ink Jet Recording Medium 14 was prepared in the same manner as Example 1, except that when Coating Composition (1) was prepared, 18.2 g of Emulsion (1) was replaced with 14.6 g of Vinyzol 480 (55 percent solids), which is an emulsion manufactured by Daido Chemical Industry Co., Ltd.).

### Comparative Example 1

Ink Jet Recording Medium 15 was prepared in the same manner as Example 1, except that when Coating Composition (1) was prepared, Emulsion (1) was not added, and 80 ml of 10 percent aqueous polyvinyl alcohol solution was replaced with 160 ml of the same.

### Comparative Example 2

Ink Jet Recording Medium 16 was prepared in the same manner as Example 1, except that gas phase method silica (Reorosil QS-20, manufactured by Tokuyama Corp.) was replaced with wet process method silica (Finesil X-37, manufactured by Tokuyama Corp.) of the same weight.

### Comparative Example 3

Ink Jet Recording Medium 17 was prepared in the same manner as Example 1, except that when Coating Composition (1) was prepared, Emulsion (1) was replaced with Emulsion (13), described in Table 1, having the same amount.

### Comparative Example 4

Ink Jet Recording Medium 18 was prepared in the same manner as Example 1, except that when Coating Composition (1) was prepared, 18.2 g of Emulsion (1) was replaced with 13.6 g of Emulsion (14) described in Table 1, and 80 ml of 10 percent aqueous polyvinyl alcohol solution was replaced with 140 ml of the same.

### Comparative Example 4

Ink Jet Recording Medium 19 was prepared in the same manner as Example 1, except that when Coating Composition (1) was prepared, 18.2 g of Emulsion (1) was replaced with 36.4 g of Emulsion (4) described in Table 1, and 80 ml of 10 percent aqueous polyvinyl alcohol solution was replaced with 373 ml of the same.

Each of Ink Jet Recording Media 1 through 19, prepared as above, was evaluated for the following items.

(1) Flexibility of Recording Surface

Each of said ink jet recording media was rehumidified at 23° C. and 20 percent relative humidity for 24 hours. Thereafter each sample was wound onto a cylindrical stainless steel rod having a diameter of 10 mm, 20 mm, 30 mm, and 40 mm, and the diameter of said rod, which tended to cause cracking of the ink absorbing layer, was determined. The smaller said diameter, the more flexible that ink absorbing layer was. When said diameter was less than or equal to 20 mm, the sample was assumed to be commercially viable. However, when the diameter was 30 mm, the sample was assumed to result in cracking in a less humid room. When the diameter was 40 mm, the sample was likely to cause cracking when the medium is rounded in dry condition.

(2) Adhesion Properties

Each of the ink jet recording media was rehumidified at 23° C. and 20 percent relative humidity for 24 hours. Thereafter each sample was folded so that the recording surface was outside and the state was observed in which the ink absorbing layer peeled off while forming minute powdered pieces. Said state was evaluated based on four grades.

A: almost no powder dropped

B powder slightly dropped

C: powder dropped but the sample was considered to be commercially viable

D: in addition to powdering, relatively large pieces of 0.5 mm peeled off

(3) Glossiness

A 75-degree specular gloss of the non-printed area of the recording surface of each ink jet recording medium was determined by employing a goniophotometer (VGS-101DP), manufactured by Nippon Denshoku Industries Co., Ltd.

(4) Ink Absorbability

A solid green image was printed onto each of ink jet printing media, employing an ink jet printer PM800, manufactured by Seiko Epson Co. Immediately after printing, the printed area was rubbed with fingers and image smearing was visually evaluated. The evaluation was carried out based on the 4 grades described below.

A: when rubbed with fingers, no image smearing was noticed

B: when rubbed with fingers, slight image smearing was noticed

C: image was slightly stained due to smearing but readable

D: image was stained due to smearing

(5) Cracking

Surface of the ink absorbing layer is observed through a magnifier in an area of 100 cm².

A: No cracking is observed.

B: No cracking of 1.0 mm or longer and not more than 5 cracking of about 0.5 mm are observed.

C: Several number of cracking of 1.0 mm or longer and 5 or more cracking of about 0.5 mm are observed.

D: A lot of cracking on the whole surface is observed.

Table 2 shows the results.

Cracking is not evaluated for the Recording Medium 16 since the sample has rough surface and too low glossiness.

TABLE 2

| | Average | | | | Ratio of | |
|---|---|---|---|---|---|---|
| | Diameter | | | | Fine | |
| | of Fine | | | | Inorganic | Emulsion |
| | Inorganic | | | | Particles | Ratio in |
| | Particles | | Emulsion | | to Binders | Binders |
| Recording | 60 | nm | Emulsion | (1) | 5:1 | 50% |
| Medium 1 | | | | | | |
| Recording | 58 | nm | Emulsion | (2) | 4:1 | 10% |
| Medium 2 | | | | | | |
| Recording | 62 | nm | Emulsion | (3) | 5:1 | 50% |
| Medium 3 | | | | | | |
| Recording | 59 | nm | Emulsion | (4) | 5:1 | 30% |
| Medium 4 | | | | | | |
| Recording | 64 | nm | Emulsion | (5) | 3:1 | 30% |
| Medium 5 | | | | | | |
| Recording | 55 | nm | Emulsion | (6) | 5:1 | 30% |
| Medium 6 | | | | | | |
| Recording | 68 | nm | Emulsion | (7) | 4:1 | 7% |
| Medium 7 | | | | | | |
| Recording | 58 | nm | Emulsion | (8) | 5:1 | 50% |
| Medium 8 | | | | | | |
| Recording | 62 | nm | Emulsion | (9) | 5:1 | 10% |
| Medium 9 | | | | | | |
| Recording | 63 | nm | Emulsion | (10) | 3:1 | 10% |
| Medium 10 | | | | | | |
| Recording | 61 | nm | Emulsion | (11) | 5:1 | 30% |
| Medium 11 | | | | | | |
| Recording | 58 | nm | Emulsion | (12) | 5:1 | 30% |
| Medium 11 | | | | | | |
| Recording | 52 | nm | Emulsion | (3) | 3:1 | 3% |
| Medium 13 | | | | | | |
| Recording | 60 | nm | Vinyzol | 480 | 5:1 | 50% |
| Medium 14 | | | | | | |
| Recording | 59 | nm | not added | | 5:1 | — |
| Medium 15 | | | | | | |
| (Comparative | | | | | | |
| Example) | | | | | | |
| Recording | 2.8 | μm | Emulsion | (1) | 4:1 | 50% |
| Medium 16 | | | | | | |
| (Comparative | | | | | | |
| Example) | | | | | | |
| Recording | 66 | nm | Emulsion | (13) | 5:1 | 50% |
| Medium 17 | | | | | | |
| (Comparative | | | | | | |
| Example) | | | | | | |
| Recording | 62 | nm | Emulsion | (14) | 4:1 | 30% |
| Medium 18 | | | | | | |
| (Comparative | | | | | | |
| Example) | | | | | | |
| Recording | 64 | nm | Emulsion | (4) | 1.5:1 | 30% |
| Medium 19 | | | | | | |
| (Comparative | | | | | | |
| Example) | | | | | | |

TABLE 2

| | Flexibility | Ad- | | | |
|---|---|---|---|---|---|
| | of | hesion | | Ink | |
| | Recording | Pro- | Glossi- | Absorb- | Crack |
| | Surface | perties | ness | ability | ing |
| Recording Medium 1 | 10 mm | A | 61% | A | B |
| Recording Medium 2 | 20 mm | B | 59% | B | C |
| Recording Medium 3 | 10 mm | A | 60% | A | A |
| Recording Medium 4 | 10 mm | A | 62% | A | B |
| Recording Medium 5 | 20 mm | B | 59% | B | B |
| Recording Medium 6 | 10 mm | A | 59% | A | B |
| Recording Medium 7 | 20 mm | B | 58% | B | C |
| Recording Medium 8 | 10 mm | A | 60% | A | B |
| Recording Medium 9 | 10 mm | A | 61% | A | C |
| Recording Medium 10 | 20 mm | B | 59% | B | B |
| Recording Medium 11 | 20 mm | B | 59% | B | A |
| Recording Medium 12 | 20 mm | A | 62% | A | A |
| Recording Medium 13 | 10 mm | A | 59% | A | A |
| Recording Medium 14 | 20 mm | A | 60% | A | B |
| Recording Medium 15 | 30 mm | C | 60% | B | C |
| (Comparative Example) | | | | | |
| Recording Medium 16 | 20 mm | B | 37% | A | (*) |
| (Comparative Example) | | | | | |
| Recording Medium 17 | 20 mm | B | 48% | A | D |
| (Comparative Example) | | | | | |
| Recording Medium 18 | 20 mm | C | 47% | A | D |
| (Comparative Example) | | | | | |
| Recording Medium 19 | 10 mm | A | 59% | D | A |
| (Comparative Example) | | | | | |

As can be seen from the results shown in Table 2, ink jet recording media of the present invention exhibited excellent flexibility of the recording surface, excellent adhesion properties, excellent glossiness, and excellent ink absorbability. Contrary to this, comparative ink jet printing media exhibited inferior flexibility of the recording surface, and inferior glossiness as well as ink absorbability.

The present invention makes it possible to provide an ink jet recording medium which exhibits high glossiness as well as a high ink absorbing rate, and results in no cracking as well as no peeling off while not forming minute pieces when rolled or folded.

1. An ink-jet recording medium comprising a support having thereon an ink absorbing layer comprising fine inorganic particles and a binder, wherein the average diameter of said fine inorganic particles is from 5 to 100 nm; said binder comprises an emulsion resin which is prepared by emulsion polymerization employing a polymer dispersing agent having a hydroxyl group; and the weight ratio of said fine inorganic particles to said binder is from 2:1 to 10:1.

2. The ink jet recording medium of claim 1, wherein said polymer dispersing agent is polyvinyl alcohol.

3. The ink jet recording medium of claim 2, wherein the polyvinyl alcohol having an average degree of polymerization of 1,500 to 5,000.

4. The ink jet recording medium of claim 1, wherein the Tg of said emulsion resin is 20° C. or less.

5. The ink jet recording medium of claim 1, wherein said binder is comprised of a water-soluble resin and an emulsion resin which is prepared by emulsion polymerization employing polyvinyl alcohol as a dispersing agent.

6. The ink jet recording medium of claim 5, wherein said water-soluble resin is polyvinyl alcohol.

7. The ink jet recording medium of claim 1, wherein the inorganic fine particles are silica prepared by a gas phase method.

8. The ink jet recording medium of claim 1, wherein the ink absorbing layer contains a hardening agent.

9. The ink jet recording medium of claim 8, wherein the amount of boric acid, or a salt thereof, in said ink absorbing layer is from 0.2 to 2 g/m².

10. The ink jet recording medium of claim 1, wherein said support is a non-water absorbing support.
